(19) United States
(12) Patent Application Publication
(10) Pub. No.: US 2026/0208309 A1
(43) Pub. Date: Jul. 23, 2026

(54) Shielding device of opening portion for a bridge type machine tool

(71) Applicant: DN SOLUTIONS CO., LTD, Changwon (KR)

(72) Inventors: Hwan Kim, Changwon (KR); Seongdae Noh, Changwon (KR)

(21) Appl. No.: 19/453,069

(22) Filed: Jan. 20, 2026

(30) Foreign Application Priority Data
Jan. 23, 2025 (KR) 10-2025-0009946

(51) Int. Cl. B23Q 11/08

(52) U.S. Cl. CPC B23Q 11/0825; B23Q 11/0816

(57) ABSTRACT

In a bridge type machine tool, a cover is installed in a vertical direction to surround a side edge of a table, and on one side of the cover where a tool magazine and an automatic tool changer are installed, an opening portion is provided so that a cross rail can be raised and lowered. In the opening portion, a multi-stage slide cover is installed that can be moved in an up-down direction (Z-axis) and slid in a left-right horizontal direction (X-axis). The slide cover is slidable in the left-right direction (X-axis) by an open and close device mounted on one side of the opening portion, thereby shielding the opening portion during a machining work so that chips or cutting fluid do not scatter outward through the opening portion, and opening the opening portion during a tool change operation so that the tool change operation between the automatic tool changer and the ram spindle is not impeded.

### CROSS REFERENCE TO RELATED APPLICATION

This application claims priority to Korean Patent Application No. 10-2025-0009946, filed on Jan. 23, 2025, the entire disclosure of which is incorporated herein by reference in its entirety.

### TECHNICAL FIELD

The present invention relates to a shielding device of an opening portion for a bridge type machine tool (Double Column Machining Centers), and more particularly, to a device for opening and closing a slide cover installed in an opening portion for a bridge type machine tool.

### BACKGROUND OF THE INVENTION

As a machine tool for processing large workpieces, a bridge type machine tool has been used.

FIG. 1 is, as a prior-art, a perspective view of a portion of a bridge type machine tool, showing a partial enlarged view in which a tool-change region below a cross rail (30) is in an open state.

As shown in FIG. 1, the bridge type machine tool generally includes a table (10) that moves in a left-right horizontal direction (X-axis), two columns (20) installed vertically (Z-axis) on opposite sides of the table (10), and a cross rail (30) mounted on the columns (20) in a fore-aft horizontal direction (Y-axis) and is movable in an up-down direction (Z-axis).

The cross rail (30) is equipped with a saddle (41), and a ram spindle (40) having a rotary tool mounted on the saddle (41) in a horizontal or vertical direction is installed.

In this case, the ram spindle (40) is mounted together with the saddle (41) on the cross rail (30) to be movable across the table (10) in the fore-aft horizontal direction (Y-axis).

The bridge type machine tool, for various machining works, includes a tool magazine (50) containing various tools on one side of the machine tool, more precisely on one side of the column (20). Between the tool magazine (50) and a body of the bridge type machine tool, an automatic tool changer (ATC) (51) is installed to exchange a tool between the ram spindle (40) and the tool magazine (50) when the ram spindle (40) on the cross rail (30) moves to a tool-exchange position.

Such a bridge type machine tool has the table (10) that moves in a left-right horizontal direction (X-axis), the cross rail (30) that moves in an up-down direction (Z-axis), and a ram spindle (40) that moves in a fore-aft horizontal direction (Y-axis), machining a workpiece mounted on the table (10) with a rotary tool.

Meanwhile, the bridge type machine tool includes a cover (52) or a door around the table (10) to prevent a cutting fluid or chips that are dispersed during the machining work from scatterring to the outside.

However, the cover (52) or door cannot be installed under a region of the cross rail (30) where the automatic tool changer (ATC) (51) is installed because an opening portion (60) must be formed at such the region so that the cross rail (30) carrying the ram type spindle (40) can move up and down to a same position as the automatic tool changer (51) for a tool change operation.

Therefore, the opening portion (60) corresponding to a tool-change area beneath the cross rail (30) where no cover (52) or door is installed can allow a cutting fluid or chips generated during a workpiece machining work to be scattered onto the automatic tool changer (ATC) (51) or the tool magazine (50) installed outside the machining region, or onto a surrounding floor area.

The chips and cutting fluid scattered through the opening portion (60) become deposited on surrounding equipment, including the automatic tool changer (51) or the tool gripping portion of the tool magazine (50), causing poor tool gripping during the tool exchange operation or malfunction of the automatic tool changer (51), and providing a cause for malfunction of the machine tool.

Furthermore, chips or cutting fluid that fall onto the floor area contaminate the surroundings and threaten the safety of workers.

The following prior-art patent documents do not disclose a shielding structure for preventing cutting fluid or chips from being scattered toward the automatic tool changer (51) and the opening portion (60).

### PRIOR ART DOCUMENTS

### Patent Documents

(Patent Document 1) Korean Patent Laid-Open Publication No. 10-2019-0074777

(Patent Document 2) Korean Patent Laid-Open Publication No. 10-2011-0135587

### DISCLOSURE OF THE INVENTION

### Problem to Be Solved

The purpose of the present invention, in order to solve the above problems, is to prevent chips or cutting fluid from being dispersed outward through an opening portion under the cross rail of a bridge type machine tool, which occurs because a cover or door shielding an interior processing region of the machine tool from an outside is not installed.

Furthermore, another object of the present invention is to prevent chips and cutting fluid from being dispersed through an opening portion and accumulating onto a tool magazine and an automatic tool changer, which could cause operational errors or malfunctions, and to also prevent contamination of a surrounding area and interference with safety of workers.

### Solution to the Problem

A shielding device of an opening portion for a bridge type machine tool of the present invention, which solves the above problems, comprises a table movable in a left-right horizontal direction (X-axis), two columns installed in a vertical direction (Z-axis) on opposite sides of the table, a cross rail mounted on the columns in a fore-aft horizontal direction (Y-axis) and movable in an up-down direction (Z-axis), a saddle mounted on the cross rail and movable in the fore-aft horizontal direction (Y-axis), a ram spindle on the saddle on which a tool is mounted to be rotatable in a horizontal or vertical direction, a tool magazine installed on one side of one column for carrying various tools, and an automatic tool changer (ATC) installed on one side of the tool magazine such that when the ram spindle on the cross rail moves to a tool-exchange position, a tool is exchanged between the spindle and the tool magazine; the shielding device comprising:
a cover installed in a vertical direction to surround a side edge of the table,
an opening portion provided at one side of the cover where the tool magazine and the automatic tool changer are installed, extending from a cross rail to a lower body of the bridge type machine tool so that the cross rail can be raised and lowered through the opening portion,
a multi-stage slide cover foldably installed in the opening portion in the up-down direction (Z-axis) and slidably movable in the left-right horizontal direction (X-axis), and
an open and close device installed on one side of the opening portion for sliding the slide cover in the left-right horizontal direction (X-axis).

Preferably, in the shielding device of the opening portion for the bridge type machine tool, an upper portion of the slide cover is connected to a lower portion of the cross rail to be slidable in the left-right horizontal direction (X-axis), a lower portion of the slide cover is connected to the lower body of the bridge type machine tool to be slidable in the left-right horizontal direction (X-axis), and when the cross rail moves in the up-down direction (Z-axis), the slide cover is unfolded or folded in the up-down direction (Z-axis) as a multi-stage slide cover.

Preferably, in the shielding device of the opening portion for the bridge type machine tool, the open and close device comprises a cylinder with a cylinder rod which is driven forward and backward by hydraulic or pneumatic pressure, wherein one end of the cylinder rod is connected to the cover and the other end thereof is connected to the slide cover.

Preferably, in the shielding device of the opening portion for the bridge type machine tool, an upper guide rail is installed beneath the cross rail and extends in the left-right horizontal direction (X-axis) toward the opening portion and fixed to the cross rail, and a lower guide rail similarly extends in the left-right horizontal direction (X-axis), correspondingly to the upper guide rail and is fixed at the lower body of the bridge type machine tool; and the upper portion of the slide cover is slidably supported in the left-right horizontal direction (X-axis) at a lower portion of the upper guide rail, and the lower portion of the slide cover is slidably supported in the left-right horizontal direction (X-axis) at an upper portion of the lower guide rail.

Preferably, in the shielding device of the opening portion for the bridge type machine tool, a cover frame is installed between the opening portion and one side of the cover and is supported to be slidably movable in the left-right horizontal direction (X-axis) relative to the body of the bridge type machine tool, wherein one side of the cover frame supports the upper guide rail and the lower guide rail to be slidably movable in the left-right horizontal direction (X-axis), and wherein further supports the upper guide rail to be slidably movable in the up-down direction (Z-axis); and wherein the other side of the cover frame is coupled to the open and close device.

Preferably, in the shielding device of the opening portion for the bridge type machine tool, a rail bar formed in a circular bar shape that allows the slide cover to slide in the left-right horizontal direction (X-axis) is coupled to the lower portion of the upper guide rail, and a linear motion guide that allows the slide cover to slide in the left-right horizontal direction (X-axis) is provided on the lower guide rail.

Preferably, in the shielding device of the opening portion for the bridge-type machine tool, a bracket is provided on the lower portion of the cross rail and a shim plate is installed between the bracket and the upper guide rail.

Preferably, in the shielding device of the opening portion for the bridge type machine tool, an X-shaped link is installed on a front or rear surface of the slide cover.

### Effect of the Invention

According to the present invention, at an opening portion under a cross rail of a bridge type machine tool, an up-down movement of the cross rail is not hindered during the tool change operation, and during a machining work an interior work region of the machine tool is shielded from the outside, thereby preventing chips or cutting fluid from scattering out through the opening portion.

In addition, the present invention prevents chips and cutting fluid from being dispersed outward through the opening portion, which would otherwise cause chips or cutting fluid to accumulate in the tool magazine and automatic tool changer to cause operational errors or malfunctions, and further prevents contamination of the surroundings and interference with safety of workers.

### BRIEF DESCRIPTION OF THE DRAWINGS

FIG. 1 is a partial perspective view of a bridge type machine tool in prior art, showing a partial enlarged view of a tool-changing region under a cross rail in an opened state.

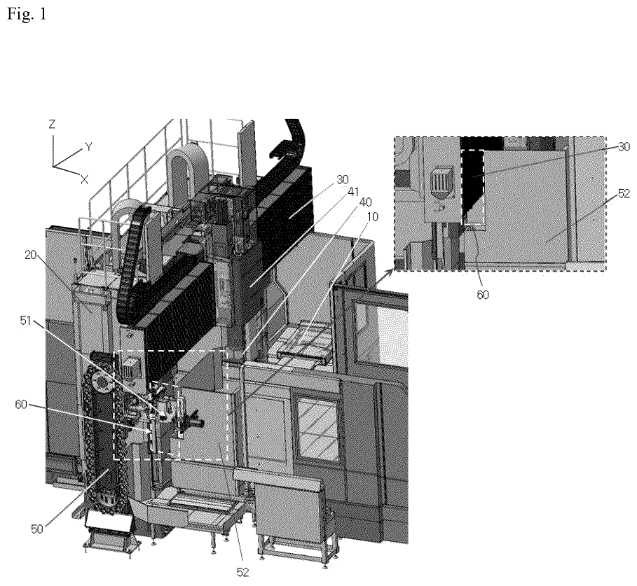

FIG. 2 is a perspective view of a bridge-type machine tool according to an embodiment of the present invention, in which a slide cover that shields interior and exterior regions is installed in an opening portion under a cross-rail.

FIG. 3 is a partial perspective view of a bridge-type machine tool according to an embodiment of the present invention, in which an open and close device is installed in an opening portion under a cross rail.

FIG. 4 is a partial perspective view of a sliding portion of the open and close device according to an embodiment of the present invention.

FIG. 5 is a partial perspective view of an open and close device according to an embodiment of the present invention as viewed from an inside of the machine tool.

FIG. 6 (a), (b) and (c) are a partial perspective view showing an operating state of an open and close device according to an embodiment of the present invention.

### DETAILED DESCRIPTION OF THE INVENTION

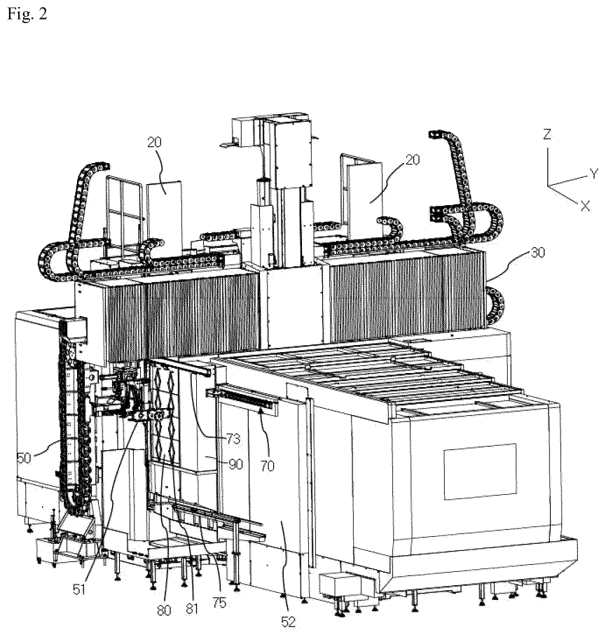

With reference to FIG. 2 to FIG. 6, preferred embodiments of the present invention are described hereinafter.

FIG. 2 is a perspective view of a bridge type machine tool according to an embodiment of the present invention, in which a slide cover (80) that shields interior and exterior regions is installed in an opening portion (60) under a cross rail (30).

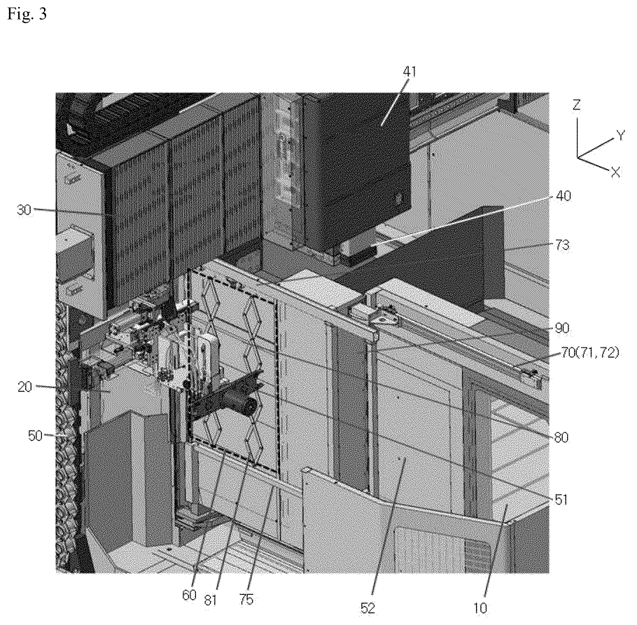

FIG. 3 is a partial perspective view of a bridge-type machine tool according to an embodiment of the present invention, showing an open and close device (70) installed in the opening portion (60) under the cross rail (30).

The bridge type machine tool includes a table (10) that moves in a left-right horizontal direction (X-axis), two columns (20) installed in a vertical direction (Z-axis) on opposite sides of the table (10), and a cross rail (30) mounted on the columns (20) in a fore-aft horizontal direction (Y-axis) and movable in an up-down direction (Z-axis).

The cross rail (30) is equipped with a saddle (41) that moves in the fore-aft horizontal direction (Y-axis), and a ram spindle (40) is installed on the saddle (41) so that a tool can be mounted at the ram spindle (40) to rotate in a horizontal or vertical direction thereof.

Therefore, the ram spindle (40) is configured to move in the horizontal direction (Y-axis) across the table (10) on the cross rail (30) together with the saddle (41). As the cross rail (30) moves in the up-down direction (Z-axis) on the column (20), the ram spindle (40) also moves in the up-down direction (Z-axis) and as the table (10) moves in the left-right horizontal direction (X-axis), the ram spindle (40) also moves in the left-right horizontal direction (X-axis) relative to the table (10).

As a result, the tool installed on the ram spindle (40) is configured to machine a workpiece mounted on the table (10) in each direction (X, Y, Z axis directions) as the ram spindle (40) rotates at high speed.

A tool magazine (50) containing various tools is installed on one side of the column (20) of the bridge type machine tool, and an automatic tool changer (ATC) (51) is installed on one side of the tool magazine (50) to exchange a tool between the ram spindle (40) and the tool magazine (50) when the ram spindle (40) moves to a tool-exchange position.

A cover (52) which is formed in a vertical direction to surround a workpiece machining region on an upper side of the table (10) is installed at side edges of the table (10) in the fore-aft horizontal direction (Y-axis) and the left-right horizontal direction (X-axis) of the table (10).

However, the cover (52) may not be provided at far ends of the left-right horizontal direction (X-axis) which is positioned at a distance far from the machining region to which scattered chips or cutting fluid do not reach.

On the one side (Y-axis direction) of the cover (52) of the bridge type machine tool where the tool magazine (50) and automatic tool changer (51) are installed, an opening portion (60) is provided from an upper cross rail (30) to a lower body of the bridge type machine tool so that the upper cross rail (30) can be raised and lowered and through the opening portion (60).

FIG. 3 is a partial perspective view of a bridge-type machine tool according to an embodiment of the present invention, illustrating an open and close device (70) installed in the opening portion (60) indicated by a dotted line under the cross rail (30).

Referring to FIG. 3, the opening portion (60) includes a multi-stage slide cover (80) that is installed to be slidable in the up-down direction (Z-axis) and movable in the left-right horizontal direction (X-axis), and an open and close device (70) installed on one side of the opening portion (60) to slide the slide cover (80) in the left-right horizontal direction (X-axis).

More specifically, the slide cover (80) is mounted in the opening portion (60) in an up-down direction (Z-axis), an upper portion of the slide cover (80) is connected to the lower part of the cross rail (30) to be slidable in the left-right horizontal direction (X-axis), a lower portion of the slide cover (80) is connected to the lower body of the bridge type machine tool to be slidable in the left-right horizontal direction (X-axis). When the cross rail (30) moves in the up-down direction (Z-axis), the slide cover (80) is foldable in the up-down direction (Z-axis) as a multi-stage slide cover.

The open and close device (70) comprises a cylinder (71) with a cylinder rod (72) installed on one side of the cover (52), and the cylinder rod (72) driven forward and backward by hydraulic or pneumatic pressure to open and close the opening portion (60).

Any one end of the cylinder (71) and the cylinder rod (72) is connected to the cover (52) and the other end is connected to the slide cover (80), thereby enabling the slide cover (80) to move in the left-right horizontal direction (X-axis).

Accordingly, the open and close device (70) is configured to move the slide cover (80) in the left-right horizontal direction (X-axis) to either communicate the opening portion (60) with the outside or to close the opening portion (60).

Meanwhile, an upper guide rail (73) is fixed at the lower portion of the cross rail (30) and extends in the left-right horizontal direction (X-axis) toward the opening portion (60) a lower guide rail (75) is fixed at the lower body of the bridge-type machine tool and extends in the same left-right horizontal direction (X-axis) as the upper guide rail (73), correspondingly to the upper guide rail (73).

Therefore, since the upper guide rail (73) is fixed to the lower portion of the cross rail (30), the upper guide rail (73) moves up and down together with the cross rail (30), while the lower guide rail (75) is fixed to the body of the bridge type machine tool and does not move.

Meanwhile, the upper portion of the slide cover (80) is supported at a lower portion of the upper guide rail (73) to be slidable in the left-right horizontal direction (X-axis), and the lower portion of the slide cover (80) is supported at a lower portion of the lower guide rail (75) to be slidable in the left-right horizontal direction (X-axis); when the cross rail (30) moves up and down, the slide cover (80) is foldable in the up-down direction (Z-axis), and when the cylinder (71) of the open and close device (70) operates, the slide cover (80) moves in the left-right horizontal direction (X-axis) to open or shield the opening portion (60), thereby allowing the tool magazine (50) and automatic tool changer (51) to be communicated with the outside or to shield the same from the outside.

The open and close device (70) is installed between the opening portion (60) and the one side of the cover (52), and is supported to be slidable in the left-right horizontal direction (X-axis) at the body of the bridge type machine tool.

One end of a cover frame (90) supports the upper guide rail (73) and the lower guide rail (75) to be slidable in the left-right horizontal direction (X-axis) and further supports the upper guide rail (73) to be slidable in the up-down direction (Z-axis), the other end of a cover frame (90) is coupled to the cylinder (71) or the cylinder rod (72).

Therefore, the cover frame (90) moves the slide cover (80) in the left-right horizontal direction in response to the left-right movement of the open and close device (70), causing the opening portion (60) to open and close. When the cross rail (30) ascends, the upper guide rail (73) that supports the slide cover (80) slides up together with the cross rail (30), so that the slide cover (80) supported at the upper portion of the upper guide rail (73) continuously maintains the opening portion (60) in a closed state.

On a front or rear surface of the multi-stage slide cover (80), an X- shaped link (81) is installed on each slide cover (80) to reinforce the lateral rigidity of the multi-stage slide cover (80).

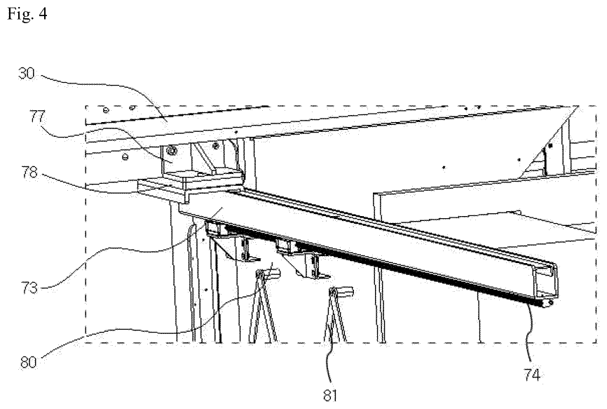

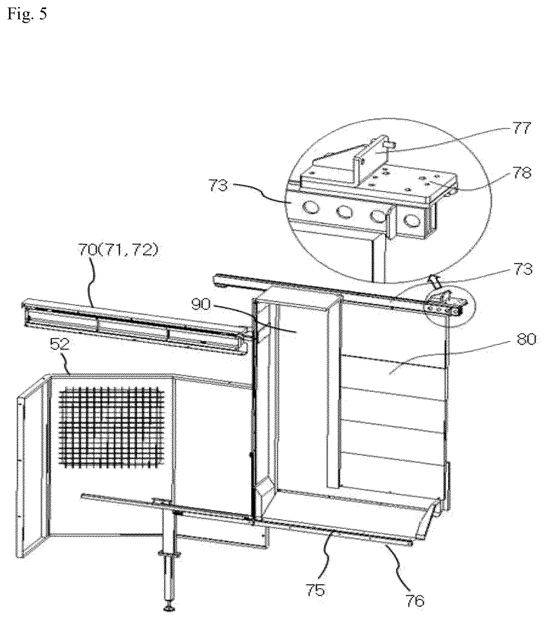

FIG. 4 is a partial perspective view of a sliding portion of the open and close device (70) and FIG. 5 is a perspective view of the open and close device (70) as viewed from an inside of the machine tool according to an embodiment of the present invention.

Referring to FIG. 4 and FIG. 5, a cylindrical rail bar (74) that allows the slide cover (80) to slide in the left-right horizontal direction (X-axis) is coupled to the lower portion of the upper guide rail (73), and a linear motion guide (76) that allows the slide cover (80) to slide in the left-right horizontal direction (X-axis) is provided on the lower guide rail (75) to form the arrangement.

A bracket (77) is coupled at the lower portion of the cross rail (30), and a shim plate (78) is installed between the bracket (77) and the upper guide rail (73) so that the upper guide rail (73) is mounted below the cross rail (30) through the bracket (77) and the shim plate (78).

By using a bracket (77) and a shim plate (78) between the upper guide rail (73) and the cross rail (30) as described above, the upper guide rail (73) may be firmly mounted to the lower portion of the cross rail (30) while simultaneously allowing precise adjustment of amounting position of the upper guide rail (73) relative to the cross rail (30).

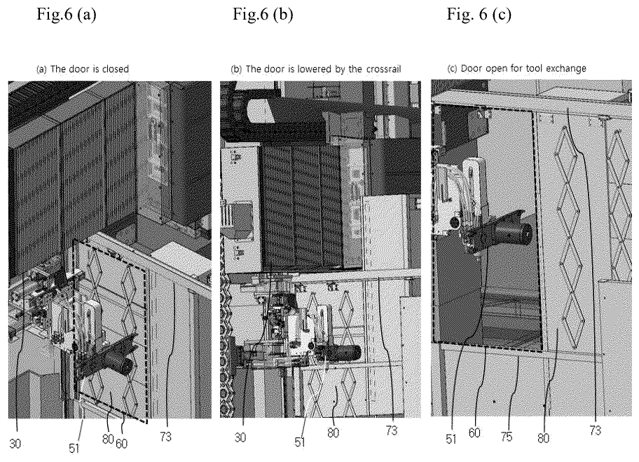

Hereinafter, referring to FIG. 6, an operation process of the present invention configured as in the above embodiment will be explained.

FIG. 6 is a partial perspective view of the present invention, showing an operating state of the open and close device (70).

First, referring to FIG. 6(a), when the cross rail (30) moves upward during a machining work of the workpiece, the slide cover (80) is expanded upward while remaining in close contact with the lower portion of the cross rail (30) together with the upper guide rail (73), so that the opening portion (60) remains in a closed state.

At this time, the cylinder (71) of the open and close device (70) extends to slide the slide cover (80) leftward on the upper guide rail (73) and lower guide rail (75), thereby maintaining the opening portion (60) in a closed state by the slide cover (80).

Therefore, chips and cutting fluid generated during the workpiece machining process by the ram spindle (40) inside the opening portion (60) are prevented from scattering through the opening portion (60) to the automatic tool changer (51) or tool magazine (50) positioned outside of the opening portion (60).

Referring to FIG. 6(b), even when the cross rail (30) moves downward during the machining work of the workpiece, the slide cover (80) is in close contact with the lower portion of the cross rail (30) together with the upper guide rail (73) and moves downward, thereby maintaining the opening portion (60) in a closed state.

Similarly, in this case the cylinder (71) of the open and close device (70) extends to slide the slide cover (80) leftward on the upper guide rail (73) and lower guide rail (75), thereby maintaining the opening portion (60) in a closed state.

Accordingly, even in this case, chips and cutting fluid generated during the machining work of the workpiece by the ram spindle (40) inside the opening portion (60) are prevented from scattering through the opening portion (60) toward the automatic tool changer (51) or tool magazine (50).

On the other hand, referring to FIG. 6(c), for the automatic tool changer (51) to exchange tools with the ram spindle (40), the slide cover (80) must open the opening portion (60) so that the automatic tool changer (51) can approach the ram spindle (40). Therefore, the cylinder (71) of the open and close device (70) operates in a retract direction to slide the slide cover (80) rightward along the upper guide rail (73) and lower guide rail (75), thereby opening the opening portion (60) and maintaining the same in an open state.

At this time, the ram spindle (40) inside the opening portion (60) is not machining the workpiece for the tool change operation, so chips and cutting fluid do not scatter outward through the opening portion (60).

As described in the foregoing embodiment, the opening portion (60) of the bridge type machine tool which allows the cross rail (30) to move up and down for the tool change operation is configured not to the interfere with up-down movement of the cross rail (30) during the tool change operation, while during the workpiece machining work the opening portion (60) is closed and shields the interior machining region of the machine tool from the outside, thereby preventing chips or cutting fluid from scattering outward.

Further, the present invention prevents chips and cutting fluid from scattering outward through the opening (60) so that chips or cutting fluid do not accumulate in the tool magazine (50) and the automatic tool changer (51) to cause operational errors or malfunctions, and additionally prevents contamination of the surroundings and interference with safety of the workers.

### REFERENCE NUMERALS

10: table
20: column
30: cross rail
40: ram spindle
41: saddle
50: tool magazine
51: automatic tool changer (ATC)
52: cover
60: opening portion
70: open and close device
71: cylinder
72: cylinder rod
73: upper guide rail
74: rail bar
75: lower guide rail
76: linear motion guide
77: bracket
78: shim plate
80: slide cover
81: X-shaped link
90: cover frame

1. A shielding device of an opening portion for a bridge type machine tool which comprises a table that moves in a left-right horizontal direction (X-axis); two columns disposed on opposite sides of the table and installed in a vertical direction; a cross rail mounted on the columns in a fore-aft horizontal direction (Y-axis) and movable in an up-down direction (Z-axis); a saddle mounted on the cross rail and movable in the fore-aft horizontal direction (Y-axis); a ram spindle mounted on the saddle and having a tool mounted to be rotatable in a horizontal or vertical direction; a tool magazine installed on one side of one column and carrying various tools; an automatic tool changer (ATC) arranged on one side of the tool magazine such that when the ram spindle on the cross rail moves to a tool-exchange position the tool is exchanged between the spindle and the tool magazine, the shielding device comprising:
a cover installed in a vertical direction to surround a side edge of the table;
an opening portion provided at one side of the cover where the magazine and the automatic tool changer are installed, extending from a cross rail to a lower body of the bridge type machine tool so that the cross rail can be raised and lowered through the opening portion;
a multi-stage slide cover foldably installed in the opening portion in the up-down direction (Z-axis) and slidably movable in the left-right direction (X-axis); and
an open and close device installed on one side of the opening portion for sliding the slide cover in the left-right direction (X-axis).

2. The shielding device of claim 1, wherein an upper portion of the slide cover is connected to a lower portion of the cross rail to be slidable in the left-right horizontal direction (X-axis), a lower portion of the slide cover is connected to the lower body of the bridge type machine tool to be slidable in the left-right horizontal direction (X-axis), and when the cross rail moves in the up-down direction (Z-axis), the slide cover is unfolded or folded in the up-down direction (Z-axis) as a multi-stage slide cover.

3. The shielding device of claim 1, wherein the open and close device comprises a cylinder with a cylinder rod which is driven forward and backward by hydraulic or pneumatic pressure, and one end of the cylinder rod is connected to the cover while the other end thereof is connected to the slide cover.

4. The shielding device of claim 1, wherein an upper guide rail is installed beneath the cross rail and extends in the left-right horizontal direction (X-axis) toward the opening portion and fixed to the cross rail, and a lower guide rail is similarly extending in the left-right horizontal direction (X-axis), correspondingly to the upper guide rail and fixed at the lower body of the bridge type machine tool,
wherein the upper portion of the slide cover is slidably supported in the left-right horizontal direction (X-axis) at a lower portion of the upper guide rail, and the lower portion of the slide cover is slidably supported in the left-right horizontal direction (X-axis) at an upper portion of the lower guide rail.

5. The shielding device of claim 4, wherein a cover frame is installed between the opening portion and one side of the cover and is supported to be slidably movable in the left-right horizontal direction (X-axis) relative to the body of the bridge-type machine tool, wherein one side of the cover frame supports the upper guide rail and the lower guide rail to be slidably movable in the left-right horizontal direction (X-axis) and wherein further supports the upper guide rail to be slidably movable in an up-down direction (Z-axis), and wherein the other side of the cover frame is coupled to the open and close device.

6. The shielding device of claim 4, wherein a rail bar formed in a cylindrical shape that allows the slide cover to slide in the left-right horizontal direction (X-axis) is coupled to the lower portion of the upper guide rail, and a linear motion guide that allows the slide cover to slide in the left-right horizontal direction (X-axis) is provided on the lower guide rail.

7. The shielding device of claim 4, wherein a bracket is provided on the lower portion of the cross rail and a shim plate is installed between the bracket and the upper guide rail.

8. The shielding device of claim 1, wherein an X-shaped link is installed on a front or rear surface of the slide cover.
